(19) United States
(12) Patent Application Publication
(10) Pub. No.: US 2026/0146678 A1
(43) Pub. Date: May 28, 2026

(54) VALVE, VALVE STEM, AND VALVE CORE

(71) Applicant: Eddie Chang, ROSEMEAD, CA (US)

(72) Inventor: Feng Tu, Shenzhen (CN)

(73) Assignee: Eddie Chang, ROSEMEAD, CA (US)

(21) Appl. No.: 19/181,701

(22) Filed: Apr. 17, 2025

(30) Foreign Application Priority Data
Nov. 27, 2024 (CN) 2024229159509
Nov. 27, 2024 (CN) 2024229205193

(51) Int. Cl. F16K 15/20; F16K 27/02

(52) U.S. Cl. CPC F16K 15/20; F16K 27/0209

(57) ABSTRACT

There is a valve provide, including a valve stem and a valve core detachably connected to one end of the valve stem. The valve stem is equipped with a first connection portion, and the valve core is equipped with a second connection portion. An outer wall of the first connection portion is equipped with external threads, and an inner wall of the second connection portion is equipped with internal threads. The valve stem and the valve core are threadedly engaged via the first connection portion and the second connection portion.

This non-provisional patent application claims priority under 35 U.S.C. § 119 from Chinese Patent Application No. 2024229205193 filed on Nov. 27, 2024, and Chinese Patent Application No. 2024229159509 filed on Nov. 27, 2024, the entire content of which is incorporated herein by reference.

### TECHNICAL FIELD

The disclosure relates to the technical field of valves, and specifically to a valve, a valve stem, and a valve core.

### BACKGROUND

Bicycle valves play a crucial role in the inflation process of bicycle tires. A typical valve includes a valve stem, a valve core, and a fixing ring. The fixing ring is configured to secure the valve to a bicycle tire. Specifically, the valve stem is equipped with external threads, and the fixing ring is internally provided with internal threads. The valve stem and the fixing ring are threadedly connected via the corresponding external threads and internal threads to secure the valve to the bicycle tire.

However, existing valves commonly adopt a connection method where the valve core is threadedly connected inside the valve stem. Specifically, external threads are provided on the valve core, and internal threads are provided on the valve stem, allowing the valve core to be threadedly connected inside the valve stem. This means that both the inner wall and outer wall of the valve stem must be provided with threads, resulting in a thinner valve stem that is prone to cracking. Furthermore, during the process of threading the valve core into the valve stem, the valve stem must withstand torque and axial forces generated by the rotation of the valve core. These forces also increase the risk of valve stem cracking. Additionally, because the valve core is fixed inside the valve stem, machining and maintenance of the valve core are inconvenient.

In view of the above, the disclosure provides a valve, a valve stem, and a valve core to reduce the risk of valve stem cracking and facilitate machining and maintenance of the valve core.

In the first aspect, the disclosure provides a valve. The valve comprises a valve stem and a valve core detachably connected to one end of the valve stem. The valve stem is equipped with a first connection portion, and the valve core is equipped with a second connection portion. An outer wall of the first connection portion is equipped with external threads, and an inner wall of the second connection portion is equipped with internal threads. The valve stem and the valve core are threadedly engaged via the first connection portion and the second connection portion.

In the second aspect, the disclosure further provides a valve stem. The valve stem is equipped with a first connection portion for connecting to a second connection portion of a valve core. An outer wall of the first connection portion is equipped with external threads, and an inner wall of the second connection portion is equipped with internal threads. The valve stem and the valve core are threadedly engaged via the first connection portion and the second connection portion.

In the third aspect, the disclosure provides a valve core. The valve core is sleeved onto a valve stem. The valve stem is equipped with a first connection portion, and the valve core is equipped with a second connection portion. An outer wall of the first connection portion is equipped with external threads, and an inner wall of the second connection portion is equipped with internal threads. The valve stem and the valve core are threadedly engaged via the first connection portion and the second connection portion.

The valve, valve stem, and valve core described above offer the following advantages: Through the provision of external threads on the outer surface of the valve stem and internal threads within the valve core, the valve core is threadedly connected to the outside of the valve stem. As a result, the valve stem of the present disclosure needs threads only on its outer wall. This makes the valve stem of the present disclosure thicker than conventional valve stems (wherein the valve core is threaded inside the valve stem), rendering it less likely to crack.

During the process of threading the valve core onto the exterior of the valve stem, the torque and axial forces generated between the valve core and the valve stem act upon the valve core instead of the valve stem. This further reduces the risk of cracking of the valve stem.

Moreover, because the valve core is threadedly connected to the exterior of the valve stem, the machining and maintenance of the valve core are simplified.

### BRIEF DESCRIPTION OF THE DRAWINGS

To more clearly illustrate the technical solutions of the embodiments of the disclosure or the prior art, the following briefly introduces the accompanying drawings used in the description of the embodiments or the prior art. It is evident that the drawings in the following description are merely some embodiments of the disclosure. For those skilled in the art, other drawings may be derived from these illustrations without creative effort.

FIG. 1 is a schematic structural diagram of a valve without a fixing ring according to an embodiment.

FIG. 2 is a schematic structural diagram of a valve with a fixing ring according to an embodiment.

FIG. 3 is an exploded view of the valve according to an embodiment.

FIG. 4 is a cross-sectional view of the valve core according to an embodiment.

FIG. 5 is a schematic structural diagram of a valve core according to an embodiment

FIG. 6 is an exploded view of the valve core according to an embodiment.

FIG. 7 is a first cross-sectional view of the valve core according to an embodiment.

FIG. 8 is a second cross-sectional view of the valve core according to an embodiment.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the disclosure and are not intended to limit the disclosure. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the disclosure are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the disclosure are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

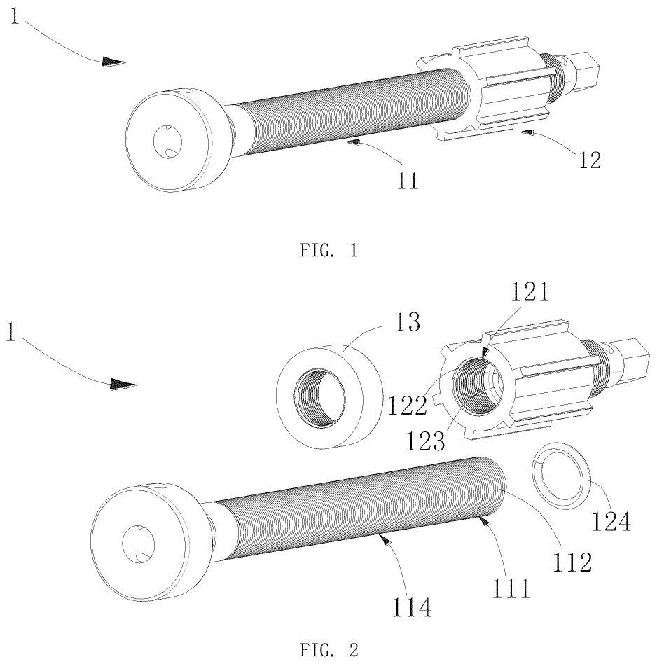

Referring to FIG. 1, a valve 1 without a fixing ring is illustrated in accordance to an embodiment. The valve 1 includes a valve stem 11, and a valve core 12 detachably connected to one end of the valve stem 11. In this embodiment, both the valve stem 11 and the valve core 12 are made of metal. In other embodiments, the valve stem 11 and the valve core 12 may also be made of other materials that meet the requirements.

Referring to FIG. 2, components of the valve are illustrated in accordance to an embodiment. The valve stem 11 is equipped with a first connection portion 111. The first connection portion 111 is configured to connect to the valve core 12. Correspondingly, the valve core 12 is equipped with a second connection portion 121, which is configured to connect to the valve stem 11. In detail, the first connection portion 111 and the second connection portion 121 work in tandem to enabled the valve stem 11 and the valve core 12 to detachably connect with each other. In this embodiment, an outer diameter of the first connection portion 111 is smaller than an inner diameter of the second connection portion 121. Simultaneously, the outer wall of the first connection portion 111 is equipped with external threads 112 for threadedly engaging with the valve core 12. The inner wall of the second connection portion 121 is equipped with internal threads 122 for threadedly engaging with the valve stem 11. This means that the valve core 12 of the disclosure is threadedly connected to the exterior of the valve stem 11.

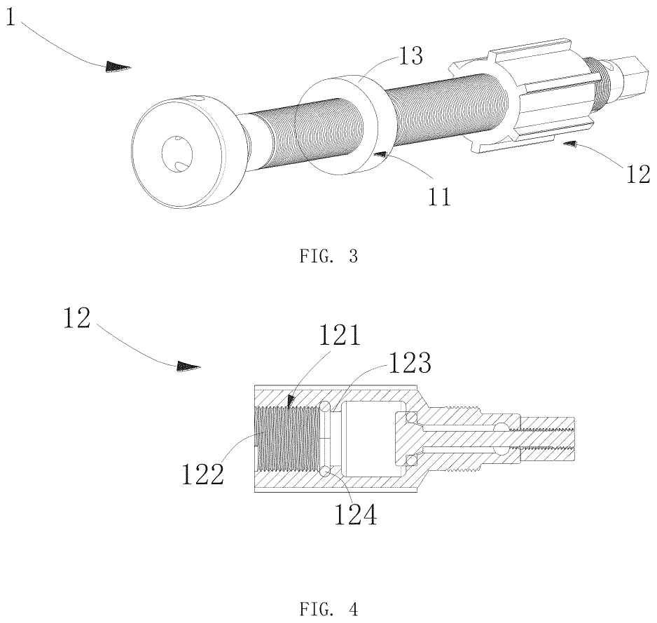

Referring to FIG. 3, a valve with a fixing ring is illustrated in accordance to an embodiment. It is understood that since a connection method where the valve core 12 is threadedly connected to the exterior of the valve stem 11, the external threads are provided on the valve stem 11. Even if the valve 1 additionally comprises a fixing ring 13 for securing the valve 1 to a bicycle tire, the external threads on the valve stem 11 can still be arranged to engage in a threaded manner with the fixing ring 13 without affecting the use of the valve 1. In other words, the valve stem 11 only needs threads on its outer wall. Consequently, the valve stem 11 is thicker than conventional valve stems, where the valve core is threaded inside the valve stem. As a result, the valve stem 11 is less likely to crack. Additionally, during the process of threading the valve core 12 onto the exterior of the valve stem 11, the torque and axial forces generated by the rotation of the valve core 12 are borne by the valve core 12 instead of the valve stem 11. This reduces the risk of cracking the valve stem 11. Furthermore, since the valve core 12 is threadedly connected to the exterior of the valve stem 11, the machining of the valve core 12 is simplified. Maintenance personnel can also easily inspect the valve core 12 for faults, which facilitates the maintenance of the valve core 12.

Referring to FIG. 4, a cross-sectional view of the valve core in accordance with an embodiment. Inside the valve core 12, a limiting portion 123 and a sealing sleeve 124 are provided. The limiting portion 123 is configured to restrict the position of the valve stem 11 when the valve stem 11 is screwed into the valve core 12. The sealing sleeve 124 is is intended to enhance the airtightness of the valve 1. Specifically, the limiting portion 123 protrudes inwardly from an end of the second connection portion 121 that is distal to the valve stem 11. As a result, when the valve stem 11 is screwed into the valve core 12, the screwing-in process of the valve stem 11 will continue until the valve stem 11 comes into contact with the limiting portion 123. The sealing sleeve 124 is positioned on the side of the limiting portion 123 that is adjacent to the valve stem 11. The function of the sealing sleeve 124 is to fill the gap between the valve stem 11 and the limiting portion 123, thereby enhancing the airtightness at the connection between the valve stem 11 and the valve core 12.

In the above described embodiments, through the provision of external threads on the outer surface of the valve stem and internal threads within the valve core, the valve core is threadedly connected to the outside of the valve stem. As a result, the valve stem in the disclosure needs threads only on its outer wall. This makes the valve stem of the disclosure thicker than conventional valve stems, rendering it less likely to crack. During the process of threading the valve core onto the exterior of the valve stem, the torque and axial forces generated between the valve core and the valve stem act upon the valve core rather than the valve stem. This further reduces the risk of cracking of the valve stem. Moreover, due to the fact that the valve core is threadedly connected to the exterior of the valve stem, the maintenance and machining of the valve core are simplified.

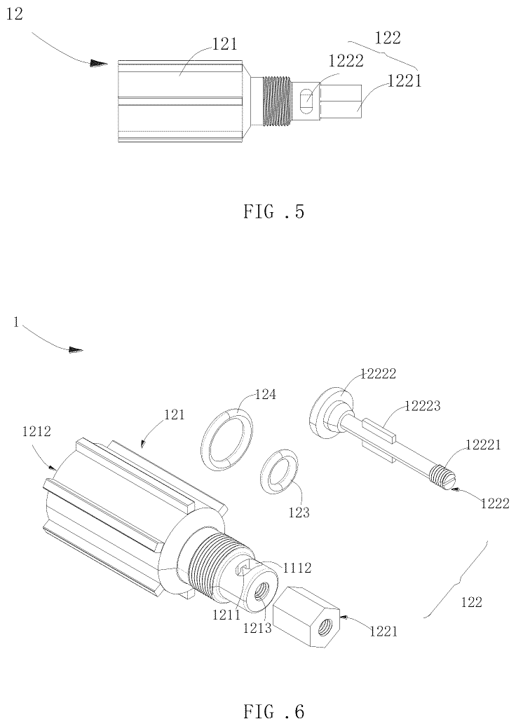

Referring to FIG. 5, the valve core 12 is illustrated in accordance with an embodiment. The valve core 12 includes a seat body 121, and a valve element 122 installed in the seat body 121. The valve element 122 includes a valve head 1221 and a core rod 1222. The core rod 1222 is detachably mounted inside the seat body 121 and partially extends out of the seat body 121. The valve head 1221 is detachably connected to the core rod 1222 and installed on exterior of the seat body 121.

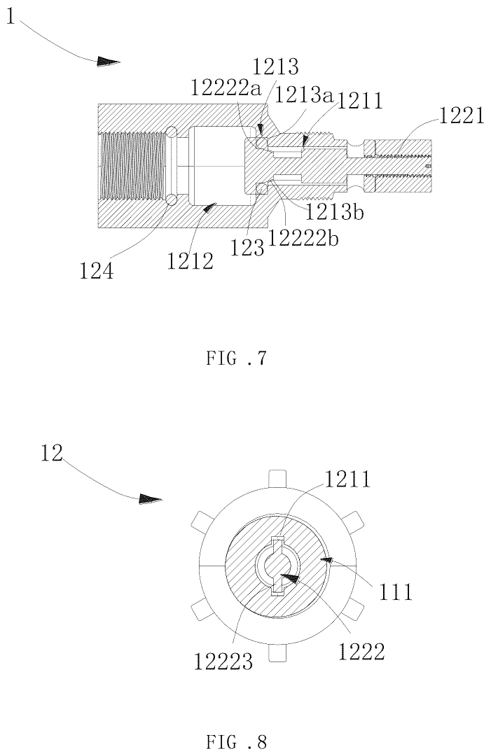

Referring to FIGS. 6 and 7, a front cross-sectional view of the valve core is illustrated in accordance with an embodiment. The seat body 121 sequentially includes a ventilation cavity 1212, a transition cavity 1213, and an accommodation cavity 1211. The sizes of the ventilation cavity 1212, the transition cavity 1213, and the accommodation cavity 1211 decrease progressively The core rod 1222 has a coupling portion 12221 at the top end of the core rod 1222 and a rod cap 12222 at the bottom end of the core rod 1222. The size of the rod cap 12222 is larger than the size of the core rod 1222. In this embodiment, the size of the ventilation cavity 1212 is larger than the size of the rod cap 12222 to allow the installation or removal of the core rod 1222 through the ventilation cavity 1212. The size of the accommodation cavity 1211 is larger than the diameter of the core rod 1222 to permit the movement of the core rod 1222 within the accommodation cavity 1211.

Referring to FIG. 7, an exploded view of the valve core is illustrated. The core rod 1222 is either fixed to or separated from the valve head 1221 through the coupling portion 12221. By dividing the valve element 122 into the valve head 1221 and the core rod 1222 and designing their connection to be detachable, the core rod 1222 can be easily removed from the seat body 121 after being separated from the valve head 1221. This facilitates the cleaning, inspection, and replacement of the valve element 122. In this embodiment, the seat body 121 defines an opening 12113 at the end of the accommodation cavity 1211 that is opposite to the ventilation cavity 1212. This opening 12113 allows the coupling portion 12221 to protrude outside the seat body 121. The outer wall of the coupling portion 12221 is equipped with external threads, while the valve head 1221 has internal threads, which enables a detachable connection between the two components. In other embodiments, alternative detachable connection methods can also be employed.

Referring again to FIG. 6, an illustration shows the valve core 12 operating in two state: an inflation state and a non-inflation state is illustrated. In the inflation state, the connection between the valve head 1221 and the core rod 1222 is loose. This causes the rod cap 12222 to disengage from the transition cavity 1213, establishing communication between the ventilation cavity 1212 and the accommodation cavity 1211. In the non-inflation state, the valve head 1221 and the core rod 1222 are tightly coupled. The rod cap 12222 seals off the transition cavity 1213, effectively isolating the ventilation cavity 1212 from the accommodation cavity 1211. Under normal operating conditions (i.e., the non inflation state), external airflow is prevented from entering the tire. When tire inflation is necessary, loosening the valve head 1221 re-establishes the connection between the two cavities. This allows airflow to enter through the ventilation hole 12112, pass into the accommodation cavity 1211, and then flow into the ventilation cavity 1212, facilitating the inflation of the tire.

The seat body 121 is equipped with a first sealing sleeve 123 positioned between the rod cap 12222 and the transition cavity 1213. This first sealing sleeve 123 is designed to fill the gaps when the rod cap 12222 blocks the transition cavity 1213. A second sealing sleeve 124 is placed within the ventilation cavity 1212 to improve the airtightness between the valve stem 11 and the ventilation cavity 1212 The rod cap 12222 is characterized by a right-angled dihedral structure 12222a, and the transition cavity 1213 has a corresponding inverted dihedral structure 113a. When the rod cap 12222 blocks the transition cavity 1213, the first sealing sleeve 123 fills the space between these two structures to guarantee airtightness. Moreover, the transition cavity 1213 has a first chamfered surface 1213b, and the rod cap 12222 is provided with a second chamfered surface 12222b. These chamfered surfaces serve to guide the insertion of the rod cap 12222 into the transition cavity 1213 and enhance the sealing effect.

Referring to FIG. 8, a side cross-sectional view of the valve core 12 is illustrated. The core rod 1222 is equipped with limiting protrusions 12223 which are designed to engage with the limiting grooves 1111 in the seat body 121. The engagement between the limiting protrusions 12223 and the limiting grooves 1111 prevents the core rod 1222 from moving relative to the seat body 121 when the core rod 1222 is being connected to or disconnected from the seat body 121. In this embodiment, two limiting protrusions 12223 and two corresponding limiting grooves 1111 are symmetrically arranged. However, the number of the limiting protrusions 12223 and the limiting grooves 1111 may be adjusted according to different implementation requirements in other embodiments.

The disclosure ensures structural stability and airtightness of the valve core while enabling convenient cleaning, inspection, and replacement of the valve element through detachable connections, sealing sleeves, and interlocking limiting mechanisms.

The above embodiments are merely illustrative of the technical solutions of the disclosure and are not intended to limit it. Although the application has been described in detail with reference to the embodiments, those skilled in the art may modify the technical solutions or replace some technical features with equivalents. Any equivalent structures derived from the description and drawings of this application, whether directly or indirectly applied to other related technical fields, shall fall within the scope of protection of the disclosure.

1. A valve, comprising:
a valve stem, having a first connection portion, an outer wall of the first connection portion is equipped with external threads; and
a valve core, having a second connection portion, an inner wall of the second connection portion is equipped with internal threads;
wherein, the valve stem and the valve core are threadedly engaged via the first connection portion and the second connection portion, as a result, the valve stem and the the valve core are detachably connected to one end of the valve stem.

2. The valve according to claim 1, wherein an outer diameter of the first connection portion is smaller than an inner diameter of the second connection portion.

3. The valve according to claim 1, wherein a limiting portion protrudes inwardly from an end of the second connection portion away from the valve stem, such that the valve stem is screwed into the valve core until abutting against the limiting portion.

4. The valve according to claim 3, wherein a sealing sleeve is further provided inside the valve core and located on a side of the limiting portion adjacent to the valve stem, to fill a gap between the valve stem and the limiting portion.

5. A valve stem, comprising a first connection portion for connecting to a second connection portion of a valve core; an outer wall of the first connection portion is equipped with external threads; an inner wall of the second connection portion is equipped with internal threads; and the valve stem and the valve core are threadedly engaged via the first connection portion and the second connection portion, as a result, the valve stem and the the valve core are detachably connected to one end of the valve stem.

6. The valve stem according to claim 5, wherein an outer diameter of the first connection portion is smaller than an inner diameter of the second connection portion.

7. A valve core, sleeved onto a valve stem equipped with a first connection portion, an outer wall of the first connection portion is equipped with external threads; wherein the valve core is equipped with a second connection portion; an inner wall of the second connection portion is equipped with internal threads; and the valve stem and the valve core are threadedly engaged via the first connection portion and the second connection portion, as a result, the valve stem and the the valve core are detachably connected to one end of the valve stem.

8. The valve core according to claim 7, wherein an outer diameter of the first connection portion is smaller than an inner diameter of the second connection portion.

9. The valve core according to claim 7, wherein a limiting portion protrudes inwardly from an end of the second connection portion away from the valve stem, such that the valve stem is screwed into the valve core until abutting against the limiting portion.

10. The valve core according to claim 9, wherein a sealing sleeve is further provided inside the valve core and located on a side of the limiting portion adjacent to the valve stem, to fill a gap between the valve stem and the limiting portion.

11. The valve core according to claim 7, further comprising:
a seat body; and
a valve element, installed in the seat body, the valve element comprising:
a valve head; and
a core rod; the core rod detachably mounted within the seat body and partially extending out of the seat body; the valve head detachably connected to the core rod and installed outside the seat body.

12. The valve core according to claim 7, wherein the valve core has an inflation state and a non-inflation state; when the valve core is in the inflation state, the valve head and the core rod are loosely connected; and when the valve core is in the non-inflation state, the valve head and the core rod are tightly connected.

13. The valve core according to claim 12, wherein the core rod is equipped with a limiting protrusion; the seat body is equipped with a limiting groove corresponding to the limiting protrusion; and the limiting groove and the limiting protrusion interlock to prevent movement of the core rod relative to the seat body during connection or disconnection of the valve head and the core rod.

14. The valve core according to claim 13, Wherein the core rod has two symmetrically-protruding limiting protrusions on the surface of the core rod; the seat body comprises an accommodation cavity and a cavity wall that surrounds the accommodation cavity; and the cavity wall is inwardly recessed at the positions on the cavity wall corresponding to the limiting protrusions to form two matching limiting grooves.

15. The valve core according to claim 14, wherein a top end of the core rod is equipped with a coupling portion; and the core rod is fixed to or separated from the valve head via the coupling portion.

16. The valve core according to claim 15, wherein an outer wall of the coupling portion is equipped with external threads; the valve head is equipped with internal threads; and the coupling portion and the valve head are detachably connected via the external and internal threads.

17. The valve core according to claim 14, wherein the seat body further defined a ventilation cavity communicating with the accommodation cavity; when the core rod and the valve head are tightly connected, the accommodation cavity and the ventilation cavity are isolated; and when loosely connected, the accommodation cavity and the ventilation cavity communicate.

18. The valve core according to claim 17, wherein a bottom end of the core rod, opposite to the coupling portion, is equipped with a rod cap; the seat body further includes a transition cavity between the ventilation cavity and the accommodation cavity; when the coupling portion and the valve head are tightly connected, the rod cap blocks the transition cavity to isolate the ventilation cavity and the accommodation cavity; and when loosely connected, the rod cap separates from the transition cavity to allow communication between the ventilation cavity and the accommodation cavity.

19. The valve core according to claim 18, wherein the seat body includes a first sealing sleeve located between the rod cap and the transition cavity to fill gaps between them when the rod cap blocks the transition cavity.
